(19) United States
(12) Patent Application Publication
(10) Pub. No.: US 2011/0112822 A1
(43) Pub. Date: May 12, 2011

(54) Talking Pen and Paper Translator

(76) Inventor: Charles Caraher, Brooklyn, NY (US)

(21) Appl. No.: 12/840,594

(22) Filed: Jul. 21, 2010

Related U.S. Application Data
(60) Provisional application No. 61/259,874, filed on Nov. 10, 2009.

(51) Int. Cl. G06F 17/28

(52) U.S. Cl. 704/3; 704/E11.001

(57) ABSTRACT

A translator made up of a pen-computer and set of translation forms. The translation forms are covered in computer-readable location data. Language names and common phrases are printed over the location data in standard text. The user points the pen-computer at the name of a language to select an output language, and then at a phrase to select an output phrase. The pen-computer, which is preloaded with audio files corresponding to each phrase, then plays a recording of the selected phrase in the appropriate language. The listener may then write a response to the phrase directly on the form.

### CROSS REFERENCES TO RELATED APPLICATIONS

This application claims the benefit of Applicant's prior provisional application, application No. 61/259,874, filed on Nov. 10, 2009.

### FIELD OF INVENTION

The invention relates to portable language translation devices where input phrases are selected from a predefined list.

### BACKGROUND

Doctors and other health care providers diagnose patients by, among other things, asking patients a series of questions. While this diagnosis interview is complicated under the best conditions, it becomes significantly more complex when the health care provider and patient do not share a common language. These communication problems create substantial delays, crowd hospitals and increase medical costs. Furthermore, inaccurate translations may lead to patient complications.

Current solutions to these communication problems are slow and expensive. For years, hospitals have hired human translators. Unfortunately, qualified human translators are expensive and often in short supply.

Some current translation systems use speech recognition software as input. However, such translation devices are often imprecise in noisy environments.

Other computer translation systems employ optical character recognition systems to “read” standard printed text as input. This method is also susceptible to data input errors. Different fonts, text size, and handwriting irregularities may further increase error rates. Such systems may require the user to pass an optical reader over an entire word or phrase before the translator can identify the input.

Prior attempts to address these problems can be found in U.S. Pat. Nos. 5,480,306 (Language learning apparatus and method utilizing optical code as input medium) and 6,434,518 (Language Translator), among others cited in the Information Disclosure Statement.

However, each of these references suffers from one or more of the following disadvantages: lack of programmability and customizability, inaccurate identification of input phrase, expense, inefficient use of physical space (such as the inability to print human readable text over the machine readable input code), lack of portability, inability to output phrases in multiple languages, and slow search or translation functions. The '306 patent, in particular, requires some sort of hardware switch to enable different output languages from a particular bar code.

An optimal translation device must provide fast and accurate translations, it must be compact, lightweight, easy to use, customizable, and appear familiar to patients.

First, the translation device must be pocketsize and lightweight. Health care providers are already overburdened with medical equipment. They are extremely reluctant to carry additional bulky tools.

Next, an ideal translation device must have a soothing, familiar appearance to patients. Patients are often in shock or groggy from medication. A complex translation apparatus may further confuse patients and impede communication. On the other hand, patients expect to see their health care providers carrying pen and paper. A translation device disguised as pen and paper helps comfort patients.

The device must be easy to use and easily customizable. Each health care provider specializes in a different area of practice, and works with patients speaking different languages. Health care providers must be able to easily change the input phrases (diagnosis questions) and output languages.

Finally, hospitals are noisy, bustling environments. A translation device must operate accurately despite background noise and commotion.

For the foregoing reasons, there is a need for an accurate, compact, customizable, easy to use language translator with a comforting, familiar appearance.

### SUMMARY

An object of the present invention is to provide a compact, accurate, rapid and easy to operate means of translation. These translation solutions are provided through the use of a translation form and a pen-computer.

The translation form may be a piece of sturdy paper. Several commonly used phrases are printed on the form. The translation form is further covered in computer readable location data. While this location data is barely noticeable to the human eye, it allows a computer to immediately pinpoint any location on the form.

The pen-computer is any type of handheld microcomputer containing at least a microprocessor and memory. The pen-computer may further contain a power source, a digital camera, and a loudspeaker. The memory is preloaded with audio files of the output phrases. The pen-computer runs software to interpret computer readable location data, correlate the location data with a specific phrase, locate the appropriate audio file in its memory, and play the audio file through the loudspeaker.

Translation is accomplished by pointing the pen-computer at a phrase on the form. The pen-computer's camera reads the location on the page, and plays the audio file containing a spoken translation of the selected phrase.

Pointing at the form serves a dual purpose. In addition to activating the translator, it brings the phrase to the patient's attention. This is especially useful if the hospital requires the patient to initial after the phrase to acknowledge receipt of instructions.

The form may also include language selection fields. The user may change the output language by pointing the pen-computer at a language selection field. This allows each translation form to function in several languages, reducing the size and weight of the device. Since the user changes the output language by merely touching a language selection region, no additional hardware switch is required. This further reduces the weight and complexity of the translator.

The questions presented by a translation form often require only simple feedback. A patient may respond with a nod of the head, by pointing a finger (for example, in response to “where does it hurt?”), or some other physical reaction. Since translation forms are easily printed and reproduced, patients may also respond by writing directly on the form, thus eliminating the need for separate intake papers.

The translator is easily customizable. Users may design and print their own forms to incorporate phrases and languages commonly used in their practice. The translation form layout may be designed with standard word processing software. The user may upload an audio recording of the phrase being spoken in the desired output language via USB, WiFi, Bluetooth or other data transfer means. The translation regions and phrase regions are defined in a corresponding Java applet. The form is then printed onto map-paper.

Although the device has been described in terms of a health care provider-patient interaction, its use is not limited to health care. Other uses, objects, advantages, and features of the invention will be evident from the following detailed description, from the claims, and from the drawings.

### BRIEF DESCRIPTION OF THE DRAWINGS

FIG. 1 illustrates a user selecting a “phrase selection” region on a translation form.

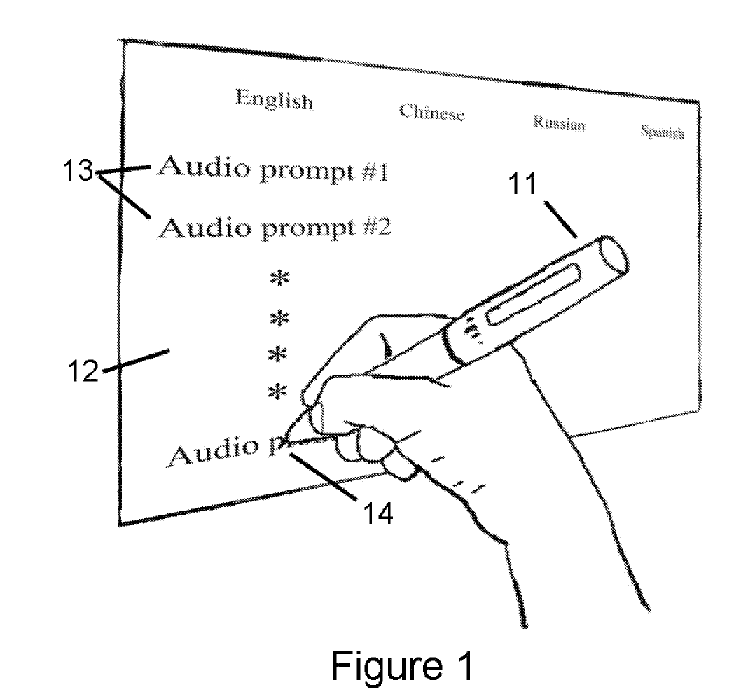

FIG. 2 illustrates a user selecting a “language selection” region on a translation region.

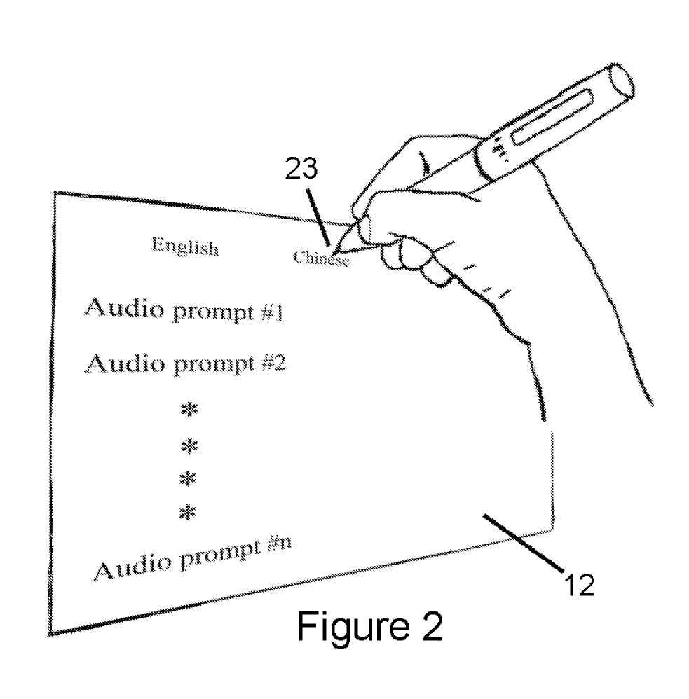

FIG. 3 illustrates an example of a pen-computer.

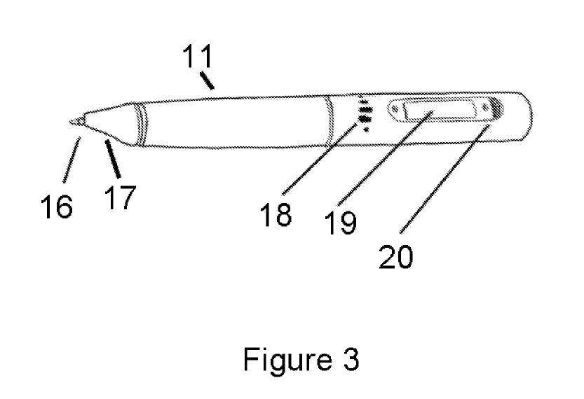

FIG. 4 illustrates a flow chart depicting the basic decision making process of the Java Applet.

FIG. 5 illustrates a translation form with example instructions.

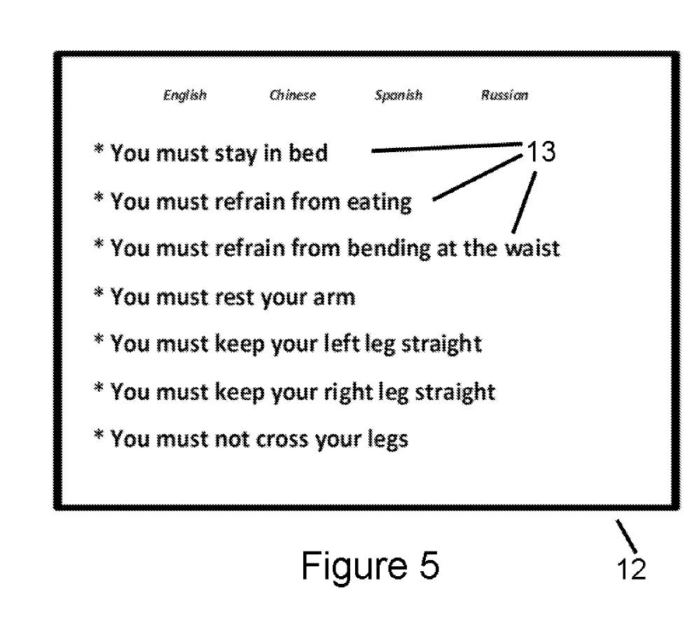

FIG. 6 illustrates a translation form used to gather information from a non-English speaking patient.

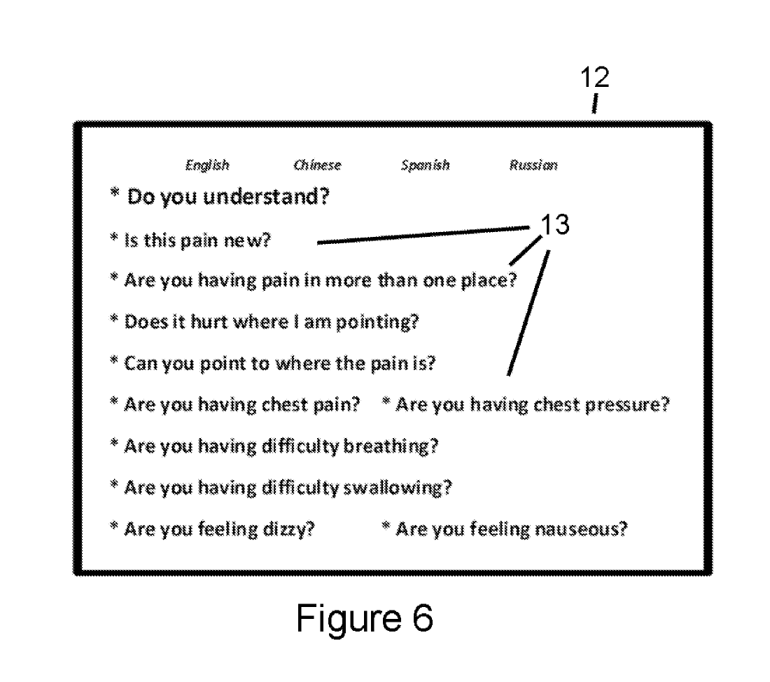

FIG. 7 illustrates a translation form with space for user input.

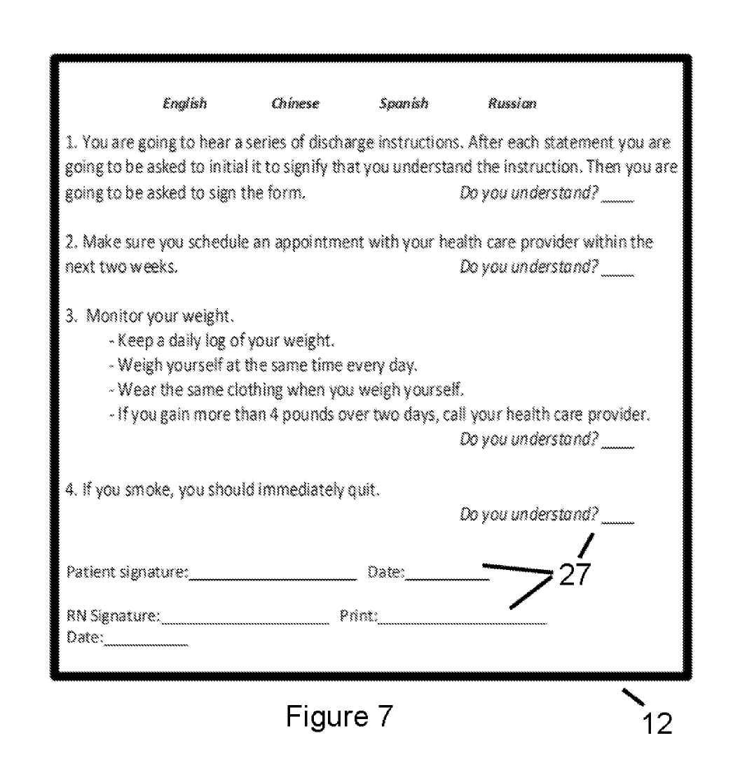

### DETAILED DESCRIPTION AND PREFERRED EMBODIMENT

In its preferred embodiment, the translator consists of a pen-computer 11 and a series of forms 12. Each form contains several printed phrases 13. To translate a phrase, the user points the pen-computer at a phrase written on the form 14. The pen-computer then plays an audio file consisting of a spoken translation of that phrase.

A Pen-Computer. A pen-computer may be any type of handheld computing device. In the preferred embodiment, it is cylindrical in shape and roughly pen-sized, it includes an ink tip 16 for handwriting, a microprocessor, memory, a battery, digital camera input 17 and loudspeaker output 18. A pen-computer may also contain an LCD display 20, an on/off switch 21, and a communications link 22, such as a USB cord, for downloading information from other computers.

Pen-computers are known in the prior art. Livescribe, Inc.'s “Pulse Smartpen” is an example of a pen-computer currently available on the market. Aspects of the Pulse Smartpen are described in U.S. Pat. No. 7,239,306 (Electronic Pen).

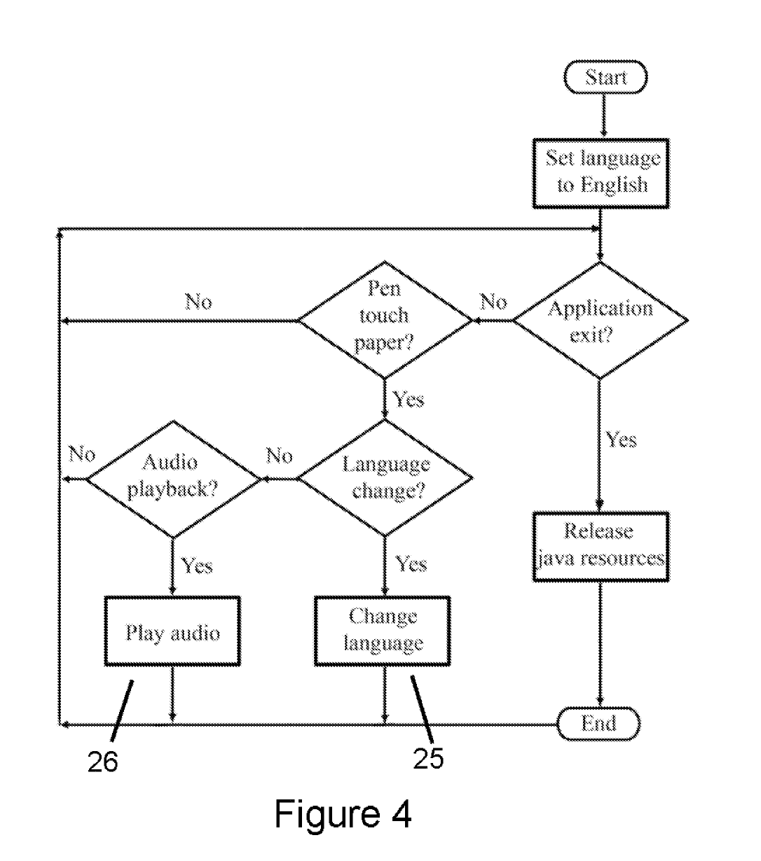

A Computer Program. In the preferred embodiment, the pen-computer contains software that operates according to the flowchart shown in FIG. 4. The software interprets computer readable location data on the translation form and identifies the phrase region or language selection region at which the user is pointing the pen-computer. If pointed at a language selection region, the software sets the output language to correspond with the language selection region indicated by the user 25. If pointed at a phrase selection region, the software locates the appropriate audio file in the memory, and plays the audio file through the loudspeaker 26.

In its preferred embodiment, the software is programmed on a personal computer using a Java Development platform with the Livescribe Standard Development Kit installed. A Java development environment, such as the Eclipse Platform, is used to program the flowchart into Java code.

Map-Paper. Map paper is any surface covered, at least partially, by areas of computer readable location data. Computer readable location data is information printed on a surface that uniquely identifies its own location upon the surface. Computer readable location data is generally unreadable by humans, and nearly or entirely unnoticeable to the naked human eye. Human readable words may be printed over computer readable location data without distracting the human reader, or disrupting a computer's ability to read the location data. Computer readable location data is known in the art and discussed in patents such as U.S. Pat. No. 7,588,191, “Product provided with a coding pattern and apparatus and method for reading the pattern.” In its preferred embodiment, the map-paper is Anoto Inc.'s “Dot-Paper.”

Translation Forms. Translation forms 12 are forms containing lists of words, phrases, or questions in the user's language. In the preferred embodiment, the forms are printed on sturdy, laminated map-paper, and bound together with a simple O-ring. The translation forms may also include one or more language selection 23 regions near the top. Language selection regions contain the name of a language printed in human readable characters.

Translation forms are divided into phrase selection regions 13. A phrase selection region contains a phrase printed in human readable characters. Each phrase selection region corresponds to a set of audio files. Each audio file in the set contains a spoken translation of the phrase in a different output language.

Translation forms may also include space 27 for users to write responses to audio prompts.

Method of Creating Forms and Programming Pen-Computer. The translation form layout may be created in word processing software. Software is then used to associate active regions (language selection regions or phrase selection regions) with the appropriate output language or output audio files.

In the preferred embodiment, the layout is exported to Adobe Acrobat, and then saved in Encapsulated PostScript (.eps) format. The Java Integrated Development Environment, utilizing the Livescribe Standard Development Kit, is used to associate regions on the translation forms to applets deployed on the pen-computer. A Livescribe “Paper Project” is created in the “Eclipse” Java Integrated Development Environment. A corresponding Livescribe “Penlet Project” is also created.

The Encapsulated PostScript file is imported into the Livescribe “Paper Project” and used as the background image. In “Paper Design” perspective, regions are defined on the Encapsulated PostScript image representation of the form. The Paper Design graphical tools are used to create “Active Regions” and the “Properties” window is used to name the defined region.

In the “Region Properties” section of the Properties window, “Edit Application List” is used to trigger the Java applet upon activation of the region.

The “PenDown” event is used to activate a Java applet. When the pen-computer touches the form, the “PenDown” event is registered, and the appropriate Java applet is activated.

In the “Penlet” perspective, the Java function penDownEventDelegator is used to set the events handled for the Regions activated. PenDownEventDelegator is activated when the Smartpen touches the translation form.

A digital audio file of each phrase being spoken is recorded in each output language. The audio file may be recorded in .wav format. Audio files are loaded into the audio subdirectory of the resource directory associated with the Project.

Finally, the translation form layout, audio files, and Java applets are downloaded to the pen-computer. The physical translation form is printed on a CMYK printer.

Of course, any software or method may be used to create the forms and program the pen-computer.

What is claimed is:

1. A translator comprising: a translation form and a pen-computer, wherein the translation form (a) is separated into a plurality of regions, (b) a word or phrase is printed in each region, (c) the translation form is covered in computer readable location data;
the Pen-Computer containing (a) an optical input means, (b) a loudspeaker output means, (c) a memory means containing a plurality of audio output files, each output file containing a recording of a translation of a word or phrase written on the form, (d) phrase identification means identifying the phrase selected on the translation form and (e) output means to output the selected audio file.

2. The translator of claim 1 wherein:
the translation form further containing a plurality of language selection regions, each language selection region correlating to an output language;
the memory means further containing a plurality of output files for each word or phrase written on the form, each output file corresponding to both (a) a language in a language selection region, and (b) a word or phrase on the form; and
the phrase identification means further identifies the last language selected by the user, and then identifies the output file corresponding to the selected word or phrase in the last selected language.

3. The translator of claim 1 wherein touching the pen-computer to the translation form activates the translation process.

4. The translator of claim 2 wherein touching the pen-computer to the translation form activates the translation process.

5. A method of communication comprising the following steps:
a. selecting a desired output language by pointing a pen-computer at a language selection area on a language translation form, said translation form being covered in computer readable location data,
b. causing the pen-computer to read the translation form's location data, identify the chosen region and change its output language accordingly,
c. selecting a phrase by pointing the pen-computer at a phrase selection area on a form,
d. reading the translation form's location data and identifying the location selected,
e. causing the pen-computer to read the translation form's location data, identify the chosen region and play the selected phrase, in the selected output language, through the pen-computer's loudspeaker.

6. The method of claim (5) where the user selects a phrase region or language region by touching the pen-computer to the translation form.

7. The method of claim (5) where the listener responds to audio output by writing a response on the translation form.

8. The method of claim (6) where the listener responds to audio output by writing a response on the translation form.

9. A computer program embodied on one or more computer useable media, comprising a plurality of audio files stored in a memory means, and instruction means for
a. taking computer readable location data from a translation form,
b. using the data to identify a region on the form,
c. correlating the region to the matching audio output file,
d. outputting the audio file to a loudspeaker.

10. The computer program of claim (9) wherein:
a. the computer program is adapted to differentiate between language selection regions and phrase selection regions,
b. when the identified region is a language selection region, the program changes its output language to the selected language,
c. when the identified region is a phrase selection region on a translation form, the program locates a the audio file corresponding to both the output language and output phrase.
